(19) United States
(12) Patent Application Publication
(10) Pub. No.: US 2026/0115844 A1
(43) Pub. Date: Apr. 30, 2026

(54) WELDING STRIP CARRIER, WELDING STRIP CARRIER ASSEMBLY, WELDING APPARATUS AND WELDING METHOD

(71) Applicant: ZHEJIANG JINGSHENG M & E CO., LTD, SHAOXING (CN)

(72) Inventors: Jiabin LU, SHAOXING (CN); LIANG ZHU, SHAOXING (CN); JIANWEI CAO, SHAOXING (CN); LINJIAN FU, SHAOXING (CN); HONGGANG GAO, SHAOXING (CN); JANGUANG ZHANG, SHAOXING (CN); CHAO YANG, SHAOXING (CN); ZEHAO ZHANG, SHAOXING (CN)

(73) Assignee: ZHEJIANG JINGSHENG M & E CO., LTD, SHAOXING (CN)

(21) Appl. No.: 19/150,688

(22) PCT Filed: Oct. 7, 2023
(86) PCT No.: PCT/CN2023/123211

§ 371 Date: Jul. 24, 2025

(30) Foreign Application Priority Data
Dec. 5, 2022 (CN) 2022115464003

(51) Int. Cl. B23K 37/047; B23K 101/36

(52) U.S. Cl. CPC B23K 37/047; B23K 2101/36

(57) ABSTRACT

This application relates to the field of photovoltaic technologies, and in particular, to a welding ribbon carrier, a welding ribbon carrier assembly, a welding device, and a welding method, including: a carrier body, where the carrier body is configured to wind a welding ribbon, the carrier body has a rotational degree of freedom, the carrier body is provided with at least one operating surface, the operating surface is configured as a planar structure, the welding ribbon is routed across the operating surface, the operating surface is provided with several adsorption holes, and the welding ribbon is adsorbed and fixed by applying negative pressure to the adsorption holes. This resolves the technical problem of a complex structure of the welding device in the existing technology, and achieves a technical effect of simplifying the structure of the welding device.

### TECHNICAL FIELD

This application relates to the field of photovoltaic technologies, and in particular, to a welding ribbon carrier, a welding ribbon carrier assembly, a welding device, and a welding method.

### BACKGROUND

With the development of photovoltaic technology, to improve an electric energy conversion rate of a solar cell, a plurality of solar cells are superposed on each other and are welded together by using welding ribbons, to form a solar cell string. Therefore, to satisfy the foregoing process requirement, a welding device used for welding the solar cells to form the solar cell string comes into being.

In the existing technology, solar cells are connected to each other by using welding ribbons. First, the welding ribbon needs to be welded on a flat solar cell, therefore, the welding ribbon needs to be arranged on a surface of the solar cell, and welding between the welding ribbon and the solar cell is completed after heating and curing. Steps of welding the welding ribbon include processing steps of pulling the welding ribbon, cutting the welding ribbon, transferring the welding ribbon, arranging and placing the welding ribbon, and welding the welding ribbon. The welding ribbon has flexibility and a relatively small diameter. After the welding ribbon is cut, the welding ribbon is transferred and arranged by using a mechanical arm. Therefore, the mechanical arm for clamping the welding ribbon needs to be provided with a plurality of groups of clamping structures to clamp a plurality of groups of welding ribbons, causing a bloated and complex structure and a higher cost of the welding device.

Therefore, the technical problem of the existing technology is as follows: the structure of the welding device is complex.

### SUMMARY

This application provides a welding ribbon carrier, a welding ribbon carrier assembly, a welding device, and a welding method, to resolve the technical problem of a complex structure of the welding device in the existing technology, and achieve a technical effect of simplifying the structure of the welding device.

According to a first aspect, this application provides a welding ribbon carrier, and the following technical solutions are used.

A welding ribbon carrier, including: a carrier body, where the carrier body is configured to wind a welding ribbon, the carrier body has a rotational degree of freedom, the carrier body is provided with at least one operating surface, the operating surface is configured as a planar structure, the welding ribbon is routed across the operating surface, the operating surface is provided with several adsorption holes, and the welding ribbon is adsorbed and fixed by applying negative pressure to the adsorption holes.

Preferably, grooves are disposed on the carrier body, the groove is routed across the operating surface, adjacent grooves located on the operating surface are parallel to each other and at equal intervals, and the adsorption holes are disposed in the groove.

Preferably, the grooves are arranged on the carrier body in an equidistant helical structure, and a helical extension direction is a rotational axial direction of the carrier body.

Preferably, the carrier body is in a plate shape, and each of front and back sides of the carrier body is provided with an operating surface.

Preferably, the carrier body is in a columnar shape, the carrier body is provided with several side surfaces, and each of the side surfaces is provided with an operating surface.

Preferably, the two adjacent operating surfaces are connected to each other.

Preferably, the operating surface rotates with the carrier body to form a first state, and in the first state, the operating surface is in a horizontal state.

Preferably, clamps are respectively connected to two ends of the carrier body in a length direction, and the clamps are configured to clamp head and tail ends of the welding ribbon.

According to a second aspect, this application provides a welding ribbon carrier assembly, and the following technical solutions are used.

A welding ribbon carrier assembly, including: a carrier base; a carrier body, where the carrier body is the carrier body, and the carrier body is rotatably connected to the carrier base; and a driving piece, where the driving piece is connected to the carrier base and acts on the carrier body, and the driving piece is configured to drive the carrier body to rotate about its own axis, to enable the operating surface to reach a first state with rotation of the carrier body.

According to a third aspect, this application provides a welding device, and the following technical solutions are used.

A welding device, including: a first mechanism, where the first mechanism is successively provided with a cutting assembly, a loading assembly, a heating assembly, and an unloading assembly; and a second mechanism, where the second mechanism includes: a carrier assembly, where the carrier assembly is the carrier assembly, and the carrier assembly has a moving degree of freedom, where the carrier assembly moves among the cutting assembly, the loading assembly, the heating assembly, and the unloading assembly to correspondingly form a first station, a second station, a third station, and a fourth station; at the first station, the cutting assembly is configured to cut a welding ribbon along an edge of an operating surface; at the second station, the loading assembly is configured to arrange a solar cell on the operating surface; at the third station, the heating assembly is configured to heat the solar cell for welding the welding ribbon; and at the fourth station, the unloading assembly is configured to remove the solar cell on which the welding ribbon is welded.

According to a fourth aspect, this application provides a welding method, and the following technical solutions are used.

A welding method of a welding device, including: winding a welding ribbon on a carrier body, and arranging a carrier assembly on a first station; a cutting assembly cuts a welding ribbon on an operating surface to form a plurality of welding ribbon groups, where each operating surface is correspondingly formed with a welding ribbon group; driving the carrier assembly to sequentially perform solar cell loading at the second station, perform heating welding at the third station, and perform solar cell unloading at the fourth station, to complete welding of a welding ribbon group on a first operating surface; driving a welding ribbon carrier to be reset to the second station and switched to a second operating surface, and driving the carrier assembly to sequentially perform solar cell loading at the second station, perform heating welding at the third station, and perform solar cell unloading at the fourth station, to complete welding of a welding ribbon group on the second operating surface; and repeating the foregoing steps until welding of a welding ribbon group on each operating surface is completed.

Preferably, that a cutting assembly cuts a welding ribbon on an operating surface to form a plurality of welding ribbon groups includes: The cutting assembly cuts the welding ribbon along an edge of each operating surface, where welding ribbon groups formed after cutting are adsorbed to a corresponding operating surface by using negative pressure, each welding ribbon group has a plurality of welding ribbons, and the welding ribbons are independent and parallel to each other.

Preferably, the performing solar cell loading at the second station includes: driving the carrier body to rotate the operating surface to the horizontal state; and the loading assembly drives the solar cell to be placed on the second operating surface.

In conclusion, this application includes at least one of the following beneficial technical effects:
1. The carrier body described in this application is configured to wind a welding ribbon, the welding ribbon is wound around and passes through the operating surface, the welding ribbon is cut to form a welding ribbon group on the operating surface, and the welding ribbon is adsorbed to the operating surface by using negative pressure. The whole operating surface is jointed to the solar cell to complete welding of the welding ribbon on the solar cell. This replaces a plurality of groups of clamping structures in a conventional structure to clamp a plurality of groups of welding ribbons, thereby greatly simplifying a structure of transferring and arranging the welding ribbon. This resolves the technical problem of a complex structure of the welding device in the existing technology, and achieves a technical effect of simplifying the structure of the welding device.
2. Grooves are arranged on the carrier body in an equidistant helical structure, and adsorption holes are disposed in the groove, to improve a fixing effect on the welding ribbon by using the groove and the adsorption hole; and the equidistant helical structure enables the cut welding ribbons to be parallel to each other, and satisfies a welding requirement of the welding ribbon on the solar cell.
3. In this application, the carrier assembly is driven to move at each station, so that welding processing for the welding ribbon and the solar cell is completed on the operating surface. One carrier body may temporarily store a plurality of welding ribbon groups, and the carrier body is rotated to switch to perform welding on different operating surfaces, thereby improving processing efficiency of welding the welding ribbon. The structure of transferring and arranging the welding ribbon is simplified by sequentially translating the welding ribbon to pass through each station. By replacing the carrier body, or adjusting a quantity of wound welding ribbons on the carrier body, a spacing or a quantity of welding ribbon groups on the carrier body may be adjusted for different process requirements, to increase adjustability and expansibility.

### BRIEF DESCRIPTION OF THE DRAWINGS

FIG. 1 is a schematic diagram of a welding ribbon carrier assembly according to this application;

FIG. 2 is a schematic diagram of a welding ribbon carrier according to this application;

FIG. 3 is an enlarged view of A in FIG. 2;

FIG. 4 is a schematic diagram of a welding ribbon carrier according to an embodiment;

FIG. 5 is a schematic diagram of a station of a welding device according to this application;

FIG. 6 is a schematic diagram of a welding device according to this application; and

FIG. 7 is a schematic flowchart of a welding method according to this application.

Descriptions of reference numerals: 100. First mechanism; 110. Cutting assembly; 111. First station; 120. Loading assembly; 121. Second station; 130. Heating assembly; 131. Third station; 140. Unloading assembly; 141. Fourth station; 200. Second mechanism; 210. Carrier assembly; 211. Carrier base; 2111. Bottom plate; 2112. Bracket; 212. Carrier body; 2121. Operating surface; 2122. Groove; 2123. Adsorption hole; 2124. Clamp; 213. Driving piece; 220. Driving assembly; and 230. Welding ribbon feeding mechanism.

### DETAILED DESCRIPTION

The sequence numbers of the components in this specification, for example, “first” and “second”, are used only to distinguish the described objects, and do not have any sequence or technical meaning. However, the terms “connected” and “coupled” described in this application both include direct and indirect connection (coupling), unless otherwise specified. In the description of this application, it should be understood that orientation or position relationships indicated by terms such as “upper”, “lower”, “front”, “rear”, “left”, “right”, “vertical”, “horizontal”, “top”, “bottom”, “inner”, “outer”, “clockwise”, and “anticlockwise” are orientation or position relationships based on the accompanying drawings and are merely intended to facilitate the description of this application and simplify the description, rather than indicating or implying that the apparatus or element mentioned should have a particular orientation or be constructed and operated in a particular orientation, and therefore should not be interpreted as limiting this application.

In this application, unless specifically defined and limited otherwise, that the first feature is “above” or “below” the second feature may be direct contact of the first and second features, or indirect contact of the first and second features through an intermediate medium. In addition, that the first feature is “above”, “over”, or “on” the second feature may indicate that the first feature is directly above or obliquely above the second feature, or may merely indicate that the horizontal position of the first feature is higher than that of the second feature. That the first feature is “below”, “under”, and “beneath” the second feature may be that the first feature is right below the second feature or at an inclined bottom of the second feature, or may merely indicate that the horizontal position of the first feature is lower than that of the second feature.

Embodiments of this application provide a welding ribbon carrier, a welding ribbon carrier assembly 210, a welding device, and a welding method, to resolve the technical problem of a complex structure of the welding device in the existing technology, and achieve a technical effect of simplifying the structure of the welding device.

To better understand the foregoing technical solutions, the following describes the foregoing technical solutions in detail with reference to the accompanying drawings and specific implementations of the specification. It should be understood that the specific embodiments described herein are only used to explain this application, and are not used to limit this application.

To implement overlapping tile production of the solar cells, welding ribbons need to be welded on the solar cells. Therefore, a welding device of the welding ribbon or an auxiliary device used for cooperating with welding of the welding ribbon comes into being. An existing mainstream welding ribbon arrangement technology includes the following several steps: pulling the welding ribbon, cutting the welding ribbon, transferring the welding ribbon, arranging and placing the welding ribbon, and welding the welding ribbon. For example, a welding ribbon automatic arrangement apparatus and a series welding machine designed by Ningxia Xiaoniu Automation Equipment Co., Ltd, where the welding ribbon automatic arrangement apparatus includes a welding ribbon cutting apparatus, a welding ribbon arrangement apparatus, a welding table, and a pulling table, a pick-and-place mechanism in the welding ribbon arrangement apparatus, which performs transverse displacement perpendicular to a direction of a welding ribbon line, is used for picking up and placing the welding ribbon, and a cutting mechanism is used for cutting an entire welding ribbon into a plurality of segments, to accurately arrange the welding ribbon on a grid line of the solar cell; and a multi-wiring multi-main grid series connection device and a series connection method of a solar cell string proposed by Zhongnengchuang Optoelectronic Technology (Changzhou) Co., Ltd, where the multi-main grid series connection device includes a series-connected workbench and a main grid wiring mechanism, the main grid wiring mechanism is configured for main grid wiring in a first direction, and further includes a movable wiring preparing table, an auxiliary line wiring mechanism, and an auxiliary line connection mechanism, the movable wiring preparing table may be moved along a second direction perpendicular to the first direction under driving of a driving mechanism, and the movable wiring preparing table is moved to implement a plurality of times of wiring.

The foregoing device and method are all used for welding a welding ribbon of a solar cell, and problems in the procedure are as follows: 1. The wiring mechanism of the welding ribbon has poor scalability, and cannot satisfy an increasing requirement on a quantity of arranged multi-wire welding ribbons; and 2. For a multi-grid solar cell welding ribbon arrangement, a corresponding quantity of welding ribbon feed carriers are required in the existing welding ribbon arrangement technology. Not only it is difficult to replace the welding ribbon, but it also occupies a large space in the device and has a high cost. Therefore, this application provides, with regard to the shortcomings of the existing technology, a welding ribbon carrier with a simple structure and a high efficiency, a welding ribbon carrier assembly 210, a welding device, and a welding method.

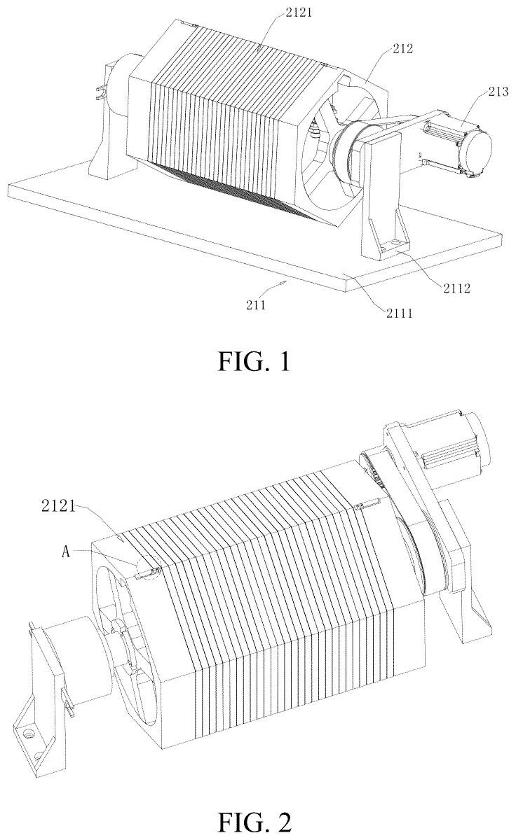

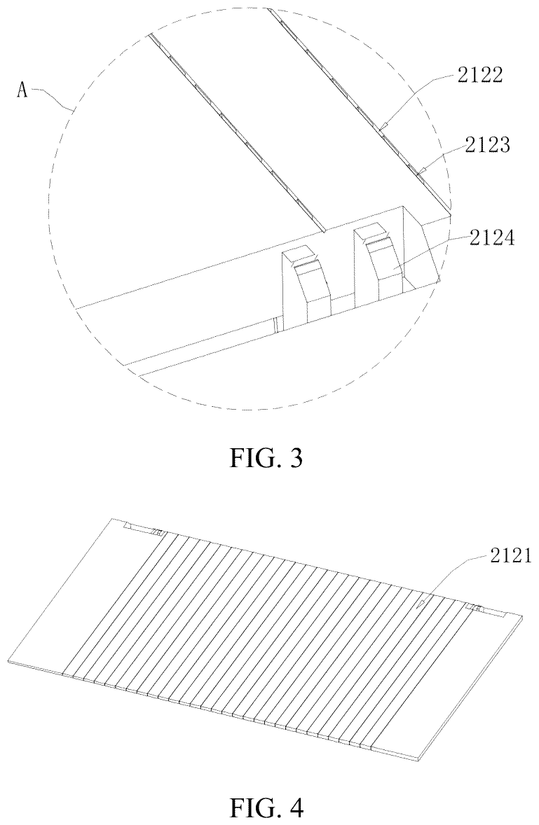

A welding ribbon carrier, as shown in FIG. 1 and FIG. 2, is used as a dependent basis of a welding ribbon, and includes a carrier body 212 and a clamp 2124; the carrier body 212 is configured to wind a welding ribbon; and the clamp 2124 is configured to clamp an end portion of the welding ribbon, so that the welding ribbon can be stably wound onto the carrier body 212.

The carrier body 212, as shown in FIG. 1 and FIG. 2, the carrier body 212 is configured to wind the welding ribbon. The carrier body 212 is provided with at least one operating surface 2121, the operating surface 2121 is a plane, and when the welding ribbon is wound onto the carrier body 212, a routing path of the welding ribbon passes through the operating surface 2121. In another embodiment, the carrier body 212 may be provided with at least two operating surfaces 2121. Similarly, the welding ribbon is wound onto the carrier body 212, and the routing path of the welding ribbon passes through each operating surface 2121. The carrier body 212 has a rotational degree of freedom. Specifically, the carrier body 212 can rotate about an axial center of the carrier body 212, so that the operating surface 2121 on the carrier body 212 rotates. The operating surface 2121 rotates with the carrier body 212 to form a first state, and in the first state, the operating surface 2121 is disposed in a horizontal state. In other words, when the carrier body 212 is provided with a plurality of operating surfaces 2121, the operating surfaces 2121 sequentially reach the horizontal state as rotating with the carrier body 212. When the operating surfaces 2121 are in the horizontal state, operations of cutting, solar cell loading, welding the welding ribbon, and solar cell unloading may be sequentially performed on the operating surfaces 2121.

Further, as shown in FIG. 2 and FIG. 3, the carrier body 212 is provided with adsorption holes 2123, and the adsorption holes 2123 are disposed on a side wall of the carrier body 212. That is, a distribution area of the adsorption holes 2123 includes the operating surface 2121 and another side surface of the carrier body 212. It should be noted that, the carrier body 212 may be hollow inside, and the carrier body 212 is in communication with an external space by using adsorption holes 2123. In this way, when negative pressure is formed inside the carrier body 212, the welding ribbon may be adsorbed to the carrier body 212, thereby improving a stability effect of the welding ribbon wound onto the carrier body 212. Moreover, through adsorbing the welding ribbon by using the negative pressure, the welding ribbon can still be adsorbed to the operating surface 2121 after the welding ribbon is cut, waiting for a next process operation.

Still further, as shown in FIG. 1 to FIG. 3, to improve stability of the solar cell wound onto the carrier body 212, grooves 2122 are disposed on the carrier body 212. The groove 2122 is disposed on a surface of the carrier body 212 and is used for accommodating a welding ribbon, to limit the welding ribbon, and prevent displacement of the welding ribbon when wound onto the carrier, especially for a short welding ribbon that is obtained after cutting, thereby improving a limiting effect of the welding ribbon. Specifically, the groove 2122 is disposed on the surface of the carrier body 212 and passes through each operating surface 2121, and grooves 2122 passing through the operating surface 2121 are set parallel to each other and at equal intervals. In other words, grooves 2122 located on a same operating surface 2121 are independent from each other, parallel to and at an equal distance from each other. In an embodiment, the grooves 2122 on the carrier body 212 are set in a continuous helical structure, and a helical extension direction is along a rotational axial direction of the carrier body 212. That is, the grooves 2122 extend to two ends of the carrier body 212 in an equidistant helical structure along the rotational axial direction of the carrier body 212. In this way, the welding ribbon is wound onto the carrier body 212 along the groove 2122, so that the welding ribbons passing through the operating surfaces 2121 remain parallel to each other and at equal intervals.

It should be noted that, as shown in FIG. 3, the adsorption holes 2123 are located in the groove 2122. In an embodiment, the adsorption holes 2123 are all disposed in the grooves 2122, and welding ribbons are stably attached inside the grooves 2122 by using the adsorption holes 2123.

As shown in FIG. 1 to FIG. 3, the carrier body 212 may be provided with at least one operating surface 2121, at least two operating surfaces 2121, at least three operating surfaces 2121, at least four operating surfaces 2121, and the like. Two adjacent operating surfaces 2121 are connected to each other, connection positions of the two operating surfaces 2121 form a straight line, and a welding ribbon may be cut along the straight line, to obtain a short welding ribbon group on each operating surface 2121. The operating surface 2121 may be disposed on a side surface of the carrier body 212, the operating surfaces 2121 are the same in size, area, and shape, and the operating surfaces 2121 are parallel to an axial direction of the carrier body 212 and extend along the axial direction of the carrier body 212. When there are a plurality of operating surfaces 2121, the operating surfaces 2121 are centrosymmetrically distributed about a rotation axis of the carrier body 212. Regarding the setting of the operating surface 2121, this application provides the following several embodiments.

In an embodiment, as shown in FIG. 4, the carrier body 212 is in a plate shape, that is, the carrier body 212 is in a rectangular plate shape. The carrier body 212 has a front side and a back side, and the front side and the back side are respectively provided with the operating surfaces 2121; and the welding ribbon extends to two ends of the carrier body 212 in an equidistant helical structure along a plate-shaped axial direction, so that parallel and equidistant grooves 2122 are routed on the operating surfaces 2121 on both the front side and the back side.

In another embodiment, the carrier body 212 is in a columnar shape, that is, the carrier body 212 is a cylinder with an equal diameter, and the operating surface 2121 is disposed on a side surface of the cylinder. There may be a plurality of operating surfaces 2121, the plurality of operating surfaces 2121 are centrosymmetrically set about an axial direction of the cylinder, and each operating surface 2121 is parallel to the axial direction of the cylinder; and two adjacent operating surfaces 2121 are connected to each other. For example, the shape of the carrier body 212 may be a right triangular prism, a right quadrangular prism, a right pentagonal prism, a right hexagonal prism,. and a right n prism. Certainly, in order that a length of a welding ribbon on the operating surface 2121 satisfies a requirement of a solar cell, a size and a shape of the operating surface 2121 of the carrier body 212 are properly selected. Preferably, as shown in FIG. 1 and FIG. 2, the carrier body 212 may be in a shape of a right triangular prism, a right quadrangular prism, a right pentagonal prism, a right hexagonal prism, or a right heptagonal prism; and the welding ribbon extends to two ends of the carrier body 212 in an equidistant helical structure along the axial direction of the cylinder, so that parallel and equidistant grooves 2122 are routed on the operating surfaces 2121 on the side surface of the cylinder.

In this way, when the carrier body 212 uses an axial center as a rotation center, each operating surface 2121 rotates with the carrier body 212, so that each operating surface 2121 can reach a first state, that is, the operating surfaces 2121 are maintained to be horizontal.

It may be understood that, by replacing the carrier body 212, or adjusting a quantity of wound welding ribbons on the carrier body 212, a spacing or a quantity of welding ribbon groups on the carrier body 212 may be adjusted for different process requirements, to increase adjustability and expansibility.

The clamp 2124, as shown in FIG. 3, the clamp 2124 is configured to clamp an end portion of the welding ribbon, so that the welding ribbon can be stably wound onto the carrier body 212. The clamp 2124 includes a collet, the carrier body 212 is hollow inside, the carrier body 212 is provided with a through-hole, the collet penetrates the carrier body 212 through the through-hole, and the collet is used for clamping the welding ribbon wound on the carrier body 212. There are two groups of clamps 2124, and the two groups of clamps 2124 are respectively disposed on two ends of the side surface of the carrier. Correspondingly, the carrier body should be provided with two through-holes corresponding to the collets, and the two groups of clamps 2124 respectively clamp a head and a tail of the welding ribbon. In an embodiment, the clamp 2124 is a pneumatic clamp 2124, and the collet is controlled to be open or closed through pneumatics. It should be noted that a position of the clamp 2124 is set on a straight line formed between the operating surface 2121 and the operating surface 2121, so that lengths of welding ribbons on all operating surfaces 2121 are equal.

A welding ribbon carrier assembly, as shown in FIG. 1 and FIG. 2, is used for adjusting the foregoing carrier body 212 to reach a first state, so that operating surfaces 2121 on the carrier body 212 can be maintained to be horizontal. This enables the operating surface 2121 to cooperate with another device in a horizontal state to complete operations of cutting, solar cell loading, welding the welding ribbon, and solar cell unloading; the welding ribbon carrier assembly 210 includes a carrier base 211, a carrier body 212, and a driving piece 213, and the carrier base 211 is used as a connection basis of the carrier body 212; the carrier body 212 is configured to wind a welding ribbon; and the driving piece 213 is configured to drive the carrier body 212 to rotate about its own axis.

The carrier base 211, as shown in FIG. 1, the carrier base 211 is used as a connection basis of the carrier body 212. The carrier base 211 includes a bottom plate 2111 and a bracket 2112. The bottom plate 2111 is a rectangular plate having a moving degree of freedom and may be driven to move in space; and there are two groups of brackets 2112, the two groups of brackets 2112 are fixedly connected to the bottom plate 2111, and the carrier body 212 is rotatably connected between the two groups of brackets 2112.

The carrier body 212, as shown in FIG. 1, the carrier body 212 is configured to wind the welding ribbon. The carrier body 212 is located between the two groups of brackets 2112, and the carrier body 212 is rotatably connected between the two brackets 2112 through the rotation axis, so that the carrier body 212 has a rotational degree of freedom, that is, the carrier body 212 may rotate about the axis. Specifically, a structure of the carrier body 212 is the same as that of the foregoing carrier body 212, and details are not described herein again.

The driving piece 213, as shown in FIG. 1, the driving piece 213 is configured to drive the carrier body 212 to rotate about the axis. The driving piece 213 is connected to the carrier base 211, acts on the rotation axis, and is configured to drive the rotation axis to rotate, to drive the carrier body 212 to rotate. In an embodiment, the driving piece 213 includes a motor, a synchronous belt, and a synchronous pulley. The motor is connected to the bracket 2112, and the synchronous pulley is connected to the rotation axis; and the synchronous belt is drivingly connected between the synchronous pulley and the motor. In this way, under driving of the driving piece 213, the carrier body 212 is driven to rotate. In a rotating process of the carrier body 212, the operating surface 2121 located on the carrier body 212 rotates with the carrier body 212, to sequentially reach the first state.

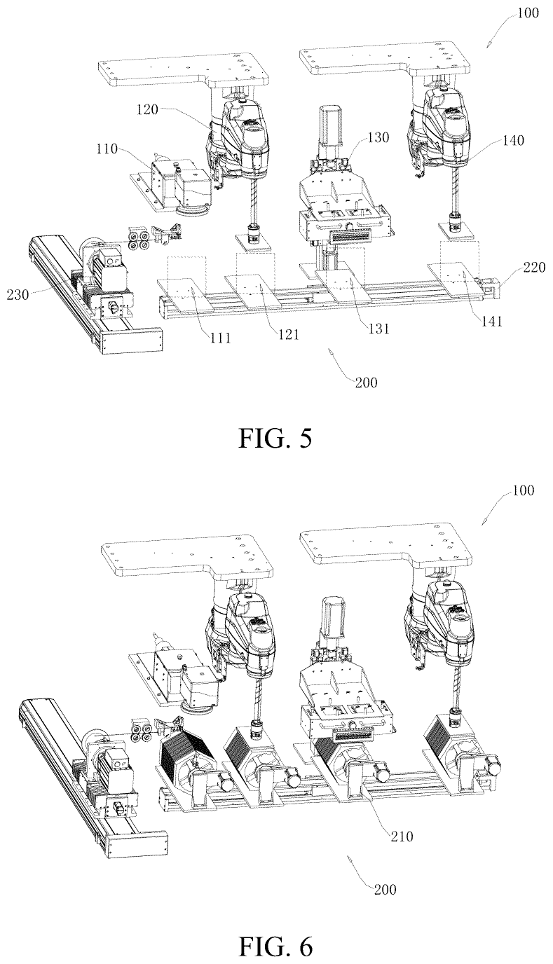

A welding device, as shown in FIG. 5, configured for welding of a welding ribbon on a solar cell. The welding device includes a first mechanism 100 and a second mechanism 200. The first mechanism 100 is used for cutting of a welding ribbon, solar cell loading, welding the welding ribbon, and solar cell unloading; and the second mechanism 200 is configured to carry a welding ribbon, and drive the welding ribbon to sequentially complete cutting of the welding ribbon, solar cell loading, welding the welding ribbon, and solar cell unloading by using the first mechanism 100.

The first mechanism 100, as shown in FIG. 5, the first mechanism 100 is used for cutting of a welding ribbon, solar cell loading, welding the welding ribbon, and solar cell unloading. The first mechanism 100 includes a cutting assembly 110, a loading assembly 120, a heating assembly 130, and an unloading assembly 140, and the cutting assembly 110, the loading assembly 120, the heating assembly 130, and the unloading assembly 140 are sequentially arranged; the cutting assembly 110 is configured to cut a welding ribbon; the loading assembly 120 is configured to arrange a solar cell on the operating surface 2121; the heating assembly 130 is configured to heat the solar cell, to enable the welding ribbon to be welded on the solar cell; and the unloading assembly 140 is configured to remove the solar cell from the operating surface 2121. In this way, a cutting area, a loading area, a heating area, and an unloading area are formed at corresponding positions of the cutting assembly 110, the loading assembly 120, the heating assembly 130, and the unloading assembly 140. In an embodiment, the cutting assembly 110, the loading assembly 120, the heating assembly 130, and the unloading assembly 140 are all located above the second mechanism 200 (a carrier assembly 210); and the second mechanism 200 drives the carrier assembly 210 to sequentially pass through the cutting assembly 110, the loading assembly 120, the heating assembly 130, and the unloading assembly 140, and a first station 111, a second station 121, a third station 131, and a fourth station 141 are correspondingly formed. In other words, the carrier assembly 210 performs cutting of the welding ribbon at the first station 111; the carrier assembly 210 performs loading of the solar cell at the second station 121; the carrier assembly 210 performs heating welding of the welding ribbon at the third station 131; and the carrier assembly 210 removes the solar cell at the fourth station 141.

In an embodiment, the cutting assembly 110 specifically uses a laser cutter, and cuts the welding ribbon by using the laser cutter, to obtain a welding ribbon group satisfying to be welded to the solar cell; the loading assembly 120 uses a form of a first mechanical arm to perform loading of the solar cell. Further, an end portion of the first mechanical arm absorbs the solar cell through vacuum adsorption, and drives the solar cell to be moved and placed on the operating surface 2121 of the carrier body 212; the heating assembly 130 heats the solar cell in an infrared heating manner, and an infrared heater acts on the solar cell downward, to heat the solar cell and the welding ribbon, so that the welding ribbon is heated and is welded to the solar cell; and the unloading assembly 140 uses a form of a second mechanical arm to pick up and unload the heated and welded solar cell, where for the laser cutting, the first mechanical arm, the infrared heating, and the second mechanical arm, proper position adjustment needs to be performed with reference to a position of a vision system relative to a position of the solar cell. For example, an arrangement direction of the welding ribbon on the solar cell may be adjusted by rotating the solar cell by using the first mechanical arm.

The second mechanism 200, as shown in FIG. 5, the second mechanism 200 is configured to carry a welding ribbon, and drive the welding ribbon to sequentially complete cutting of the welding ribbon, solar cell loading, welding the welding ribbon, and solar cell unloading by using the first mechanism 100. The second mechanism 200 is located below the first mechanism 100. Specifically, the second mechanism 200 includes a carrier assembly 210 and a driving assembly 220, and the carrier assembly 210 is configured to carry a welding ribbon. A structure of the carrier assembly 210 is the same as that of the foregoing carrier assembly 210, and the structure of the carrier assembly 210 is not described herein again; and the driving assembly 220 is connected to and acts on the carrier assembly 210, and is configured to drive movement of the carrier assembly 210.

The carrier assembly 210, as shown in FIG. 5, is configured to carry a welding ribbon. The carrier assembly 210 is located below the first mechanism 100. The carrier assembly 210 has a moving degree of freedom under the driving of the driving assembly 220, so that the carrier assembly 210 can perform directional or reciprocating movement among the cutting assembly 110, the loading assembly 120, the heating assembly 130, and the unloading assembly 140, and the carrier assembly 210 can perform directional or reciprocating movement among the first station 111, the second station 121, the third station 131, and the fourth station 141.

The driving assembly 220, as shown in FIG. 5, the driving assembly 220 is connected to and acts on the carrier assembly 210, and is configured to drive movement of the carrier assembly 210. The driving assembly 220 uses a driving manner of a motor and a lead screw, so that the carrier assembly 210 can slide in a direction of the lead screw. It should be noted that, in the first mechanism 100, an arrangement manner of the cutting assembly 110, the loading assembly 120, the heating assembly 130, and the unloading assembly 140 should be suitable for a moving track of the carrier assembly 210. That is, the cutting assembly 110, the loading assembly 120, the heating assembly 130, and the unloading assembly 140 are located right above the lead screw, and are arranged along the direction of the lead screw.

As shown in FIG. 6, for ease of understanding, the carrier assembly 210 is separately drawn at the first station 111, the second station 121, the third station 131, and the fourth station 141, but actually there is only one set of carrier assembly 210. Driven by the driving assembly 220, the carrier assembly 210 can move among the cutting assembly 110, the loading assembly 120, the heating assembly 130, and the unloading assembly 140, to sequentially reach the first station 111, the second station 121, the third station 131, and the fourth station 141 and correspondingly complete cutting of the welding ribbon, solar cell loading, welding the welding ribbon, and solar cell unloading. Specifically, after the operating surface 2121 on the carrier body 212 is in a horizontal state, the driving assembly 220 first drives the carrier assembly 210 to reach the first station 111, and the cutting assembly 110 cuts the welding ribbon on the operating surface 2121; the driving assembly 220 further drives the carrier assembly 210 to reach the second station 121, and the first mechanical arm adsorbs a solar cell to be placed on the operating surface 2121; the driving assembly 220 further drives the carrier assembly 210 to reach the third station 131, and the heating assembly 130 acts on the solar cell downward, to heat the solar cell and complete the step of welding the welding ribbon; the driving assembly 220 further drives the carrier assembly 210 to reach the fourth station 141, and the second mechanical arm drives the solar cell on which the welding ribbon is welded to be removed from the operating surface 2121; and in this way, welding a welding ribbon on one operating surface 2121 is completed. The driving assembly 220 further drives the carrier assembly 210 back to the first station 111, and the carrier body 212 rotates to change the operating surface 2121, so that another operating surface 2121 maintains horizontal, and the foregoing steps are performed again until the welding ribbon on each operating surface 2121 is used up.

Further, a welding ribbon feeding mechanism 230 may be disposed on a side of the first station 111, and the welding ribbon feeding mechanism 230 is configured to provide welding ribbons to the carrier assembly 210. The welding ribbon feeding mechanism 230 winds the welding ribbon on the carrier body 212 guided by a guide wheel, and a process of welding the welding ribbon on the carrier body 212 may be performed after cutting. After the welding ribbon on each operating surface 2121 of the carrier body 212 is used up, the welding ribbon feeding mechanism 230 feeds the carrier body 212. In an embodiment, a linear motor is connected to the welding ribbon feeding mechanism 230, and an arrangement direction of the linear motor is perpendicular to the direction of the lead screw, so that the welding ribbon feeding mechanism 230 may move in a direction perpendicular to the lead screw, to perform position adjustment relative to the carrier body 212. In an embodiment, the welding ribbon feeding mechanism may be a windlass.

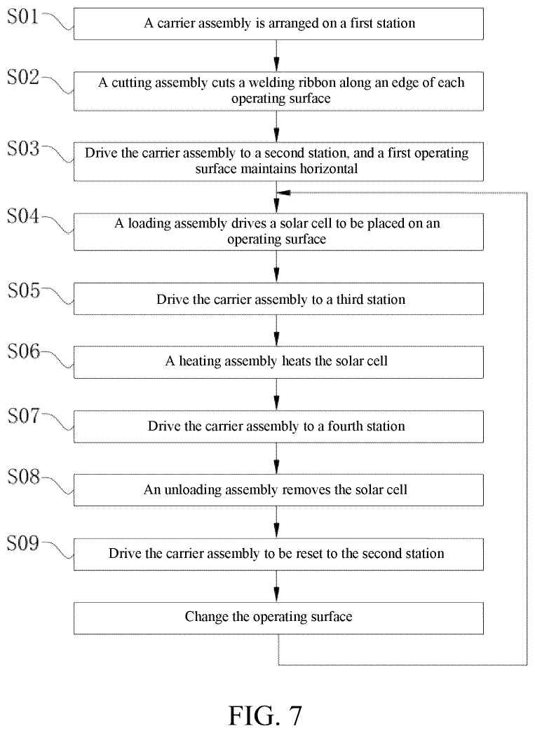

A welding method of a welding ribbon, as shown in FIG. 7, is applied to the foregoing welding device of the welding ribbon, and includes the following steps.
S01: Wind a welding ribbon on a carrier body 212, and arrange a carrier assembly 210 on a first station 111.
S02: Drive the carrier body 212 to rotate, where the cutting assembly 110 cuts the welding ribbon along an edge of each operating surface 2121, and the cut welding ribbon is adsorbed into a groove 2122 on the operating surface 2121 by using negative pressure. In this way, a welding ribbon group is formed on each operating surface 2121, each welding ribbon group is used for welding to the solar cell, each welding ribbon group has a plurality of welding ribbons, and the welding ribbons are independent and parallel to each other.
S03: Drive the carrier assembly 210 to a second station 121; and drive the carrier body 212 to rotate until the first operating surface is maintained to be in a horizontal state.
S04: A loading assembly 120 drives the solar cell to be placed on the first operating surface.
S05: Drive the carrier assembly 210 to a third station 131; and maintain the first operating surface to be in the horizontal state.
S06: A heating assembly 130 heats the solar cell, and welds the welding ribbon on the first operating surface to the solar cell. It should be noted that the surface of the welding ribbon has a tin layer structure, which enables the welding ribbon to be welded to the solar cell after being heated and melted.
S07: Drive the carrier assembly 210 to a fourth station 141.
S08: An unloading assembly 140 removes the solar cell from the first operating surface.
S09: Drive the carrier assembly 210 to be reset to the second station 121; and drive the carrier body 212 to rotate a second operating surface to the horizontal state.
S10: The loading assembly 120 drives the solar cell to be placed on the second operating surface.
S11: Drive the carrier assembly 210 to the third station 131; and maintain the second operating surface to be in the horizontal state.
S12: The heating assembly 130 heats the solar cell, and welds the welding ribbon on the second operating surface to the solar cell.
S13: Drive the carrier assembly 210 to the fourth station 141.
S14: The unloading assembly 140 removes the solar cell from the second operating surface.

Steps S09 to S14 are repeated until welding ribbon groups on all operating surfaces 2121 of the carrier body 212 are used up, that is, the welding ribbon groups on all the operating surfaces 2121 on the carrier body 212 are welded in coordination with the solar cells.

Working principles/steps:

The carrier assembly 210 can move among the cutting assembly 110, the loading assembly 120, the heating assembly 130, and the unloading assembly 140, and after the operating surface 2121 on the carrier body 212 is in a horizontal state, the driving assembly 220 first drives the carrier assembly 210 to reach the first station 111, and the cutting assembly 110 cuts the welding ribbon on the operating surface 2121; the driving assembly 220 further drives the carrier assembly 210 to reach the second station 121, and the first mechanical arm adsorbs a solar cell to be placed on the operating surface 2121; the driving assembly 220 further drives the carrier assembly 210 to reach the third station 131, and the heating assembly 130 acts on the solar cell downward, to heat the solar cell and complete the step of welding the welding ribbon; the driving assembly 220 further drives the carrier assembly 210 to reach the fourth station 141, and the second mechanical arm adsorbs the solar cell on which the welding ribbon is welded to be removed from the operating surface 2121; and in this way, welding a welding ribbon on one operating surface 2121 is completed. The driving assembly 220 further drives the carrier assembly 210 back to the first station 111, and the carrier body 212 rotates to change the operating surface 2121, so that another operating surface 2121 maintains horizontal, and the foregoing steps are performed again until the welding ribbon on each operating surface 2121 is used up.

Technical effect:
1. The carrier body 212 described in this application is configured to wind a welding ribbon, the welding ribbon is wound around and passes through the operating surface 2121, the welding ribbon is cut to form a welding ribbon group on the operating surface 2121, and the welding ribbon is adsorbed to the operating surface 2121 by using negative pressure. The whole operating surface 2121 is jointed to the solar cell to complete welding of the welding ribbon on the solar cell. This replaces a plurality of groups of clamping structures in a conventional structure to clamp a plurality of groups of welding ribbons, thereby greatly simplifying a structure of transferring and arranging the welding ribbon. This resolves the technical problem of a complex structure of the welding device in the existing technology, and achieves a technical effect of simplifying the structure of the welding device.
2. Grooves 2122 are arranged on the carrier body 212 in an equidistant helical structure, and adsorption holes 2123 are disposed in the groove 2122, to improve a fixing effect on the welding ribbon by using the groove 2122 and the adsorption hole 2123; and the equidistant helical structure enables the cut welding ribbons to be parallel to each other, and satisfies a welding requirement of the welding ribbon on the solar cell.
3. In this application, the carrier assembly 210 is driven to move at each station, so that welding processing for the welding ribbon and the solar cell is completed on the operating surface 2121. One carrier body 212 may temporarily store a plurality of welding ribbon groups, and the carrier body 212 is rotated to switch to perform welding on different operating surfaces 2121, thereby improving processing efficiency of welding the welding ribbon. The structure of transferring and arranging the welding ribbon is simplified by sequentially translating the welding ribbon to pass through each station. By replacing the carrier body 212, or adjusting a quantity of wound welding ribbons on the carrier body 212, a spacing or a quantity of welding ribbon groups on the carrier body 212 may be adjusted for different process requirements, to increase adjustability and expansibility.

Although exemplary embodiments of this application have been described, once persons skilled in the art know the basic creative concept, they can make additional changes and modifications to these embodiments. Therefore, the following claims are intended to be construed as to cover the exemplary embodiments and all changes and modifications falling within the scope of this application.

Obviously, a person skilled in the art can make various modifications and variations to this application without departing from the spirit and scope of this application.

In this case, if the modifications and variations made to this application fall within the scope of the claims of this application and their equivalent technologies, this application is intended to include these modifications and variations.

1. A welding ribbon carrier, comprising:
a carrier body (212), wherein the carrier body (212) is configured to wind a welding ribbon, the carrier body (212) has a rotational degree of freedom, the carrier body (212) is provided with at least one operating surface (2121), the operating surface (2121) is configured as a planar structure, the welding ribbon is routed across the operating surface (2121), the operating surface (2121) is provided with several adsorption holes (2123), and the welding ribbon is adsorbed and fixed by applying negative pressure to the adsorption holes (2123).

2. The welding ribbon carrier according to claim 1, wherein grooves (2122) are disposed on the carrier body (212), the groove (2122) is routed across the operating surface (2121), adjacent grooves (2122) located on the operating surface (2121) are parallel to each other and at equal intervals, and the adsorption holes (2123) are disposed in the groove (2122).

3. The welding ribbon carrier according to claim 2, wherein the grooves (2122) are arranged on the carrier body (212) in an equidistant helical structure, and a helical extension direction is a rotational axial direction of the carrier body (212).

4. The welding ribbon carrier according to claim 3, wherein the carrier body (212) is in a plate shape, and each of front and back sides of the carrier body (212) is provided with an operating surface (2121).

5. The welding ribbon carrier according to claim 3, wherein the carrier body (212) is in a columnar shape, the carrier body (212) is provided with several side surfaces, and each of the side surfaces is provided with an operating surface (2121).

6. The welding ribbon carrier according to claim 1, wherein the two adjacent operating surfaces (2121) are connected to each other.

7. The welding ribbon carrier according to claim 6, wherein clamps (2124) are respectively connected to two ends of the carrier body (212) in a length direction, and the clamps (2124) are configured to clamp head and tail ends of the welding ribbon.

8. A welding ribbon carrier assembly, comprising:
a carrier base (211);
a carrier body (212), wherein the carrier body (212) is the carrier body (212) according to claim 1, and the carrier body (212) is rotatably connected to the carrier base (211); and
a driving piece (213), wherein the driving piece (213) is connected to the carrier base (211) and acts on the carrier body (212), and the driving piece (213) is configured to drive the carrier body (212) to rotate about its own axis, to enable the operating surface (2121) to reach a horizontal state with rotation of the carrier body (212).

9. A welding device, comprising:
a first mechanism (100), wherein the first mechanism (100) is successively provided with a cutting assembly (110), a loading assembly (120), a heating assembly (130), and an unloading assembly (140); and
a second mechanism (200), wherein the second mechanism (200) comprises:
a carrier assembly (210), wherein the carrier assembly (210) is the carrier assembly (210) according to claim 8, and the carrier assembly (210) has a moving degree of freedom, wherein
the carrier assembly (210) moves among the cutting assembly (110), the loading assembly (120), the heating assembly (130), and the unloading assembly (140) to correspondingly form a first station (111), a second station (121), a third station (131), and a fourth station (141); at the first station (111), the cutting assembly (110) is configured to cut a welding ribbon along an edge of an operating surface (2121); at the second station (121), the loading assembly (120) is configured to arrange a solar cell on the operating surface (2121); at the third station (131), the heating assembly (130) is configured to heat the solar cell for welding the welding ribbon; and at the fourth station (141), the unloading assembly (140) is configured to remove the solar cell on which the welding ribbon is welded.

10. A welding method of the welding device according to claim 9, comprising:
winding a welding ribbon on a carrier body (212), and arranging a carrier assembly (210) on a first station (111);
cutting, by a cutting assembly (110), a welding ribbon on an operating surface (2121) to form a plurality of welding ribbon groups, wherein each operating surface (2121) is correspondingly formed with a welding ribbon group;
driving the carrier assembly (210) to sequentially perform solar cell loading at the second station (121), perform heating welding at the third station (131), and perform solar cell unloading at the fourth station (141), to complete welding of a welding ribbon group on a first operating surface;
driving a welding ribbon carrier to be reset to the second station (121) and switched to a second operating surface, and driving the carrier assembly (210) to sequentially perform solar cell loading at the second station (121), perform heating welding at the third station (131), and perform solar cell unloading at the fourth station (141), to complete welding of a welding ribbon group on the second operating surface; and
repeating the foregoing steps until welding of a welding ribbon group on each operating surface (2121) is completed.
